(19) United States
(12) Patent Application Publication
(10) Pub. No.: US 2005/0102819 A1
(43) Pub. Date: May 19, 2005

(54) Surface film structure of a metallic bipolar plate for fuel cells and a method for producing the same

(75) Inventors: Shuo-Jen Lee, Chung-Li (TW); Ching-Han Huang, Chung-Li (TW); Jian-Jang Lai, Chung-Li (TW); Yu-Pang Chen, Chung-Li (TW)

Correspondence Address: BRUCE H. TROXELL, SUITE 1404, 5205 LEESBURG PIKE, FALLS CHURCH, VA, 22041, US

(73) Assignee: Yuan Ze University

(21) Appl. No.: 10/921,924

(22) Filed: Aug. 20, 2004

(30) Foreign Application Priority Data
Nov. 18, 2003 (TW) 92132201

(51) Int. Cl. B32B 15/01

(52) U.S. Cl. 29/592.1; 428/666

(57) ABSTRACT

A surface film structure of a metallic bipolar plate for fuel cells and a method for producing the same are provided. The method is firstly to perform flow channel machining on a bipolar plate, then to surface grind the plate so as to remove any oxide film on the plate, to degrease the plate by dipping the plate into an alkaline solution for ultrasonic cleaning, to remove from the alkaline solution and de-ionize the plate by de-ion water, again to dip the plate into a nitric acid, to de-ionize the plate after being removed from the nitric acid, to dip the plate into pure water for further ultrasonic cleaning, and finally to arrange the plate removed from the pure water into an ECM tank for forming a surface film on the plate with both chemical and electrochemical stability. The surface film including a Cr composition of 40˜75%, an Fe composition of 10˜30%, and an Ni composition of 15˜30% provides the metallic bipolar plate superior properties in corrosion-resistance, conductivity, and roughness. For a nano-structure is also provided to the surface film, the plate is then hydrophobic and self-cleaning, and thus the surface stability and flowability can be substantially increased. Further, for the Cr composition in the surface film has been particularly increased, the corrosion resistance of the metallic bipolar plate is greatly enhanced.

### BACKGROUND OF THE INVENTION

(1) Field of the Invention

The invention relates to a metallic bipolar plate for fuel cells, and more particularly to a surface film structure of the metallic bipolar plate and a corresponding method for producing the surface film structure.

(2) Description of the Prior Art

Conventionally, a bipolar plate for a proton exchange membrane fuel cell (PEMFC) is usually produced or machined from a graphite plate. To avoid cracking during machining the brittle graphite plate, it is inevitable to produce a thicker bipolar plate. Though strength of the graphite-made bipolar plate can be substantially increased by having a thicker plate, yet disadvantages in a bulky size, a heavy weight and a higher cost are inevitable.

To overcome the aforesaid disadvantages in producing the bipolar graphite plate, injection molding is introduced to formed the bipolar plate from a mixture including graphite powders, various polymers and carbon powders. Upon such an improvement, a low-cost and light-weight bipolar plate can be produced. It is also noted that no more machining is required in injection-molding the bipolar graphite plate. In addition, the bipolar graphite plate by injection molding can have a better resistance to a highly corrosive environment existing in the fuel cell.

In the art, a metallic bipolar plate provides another option to the PEMFC. The metallic bipolar plate has various advantages such as a low cost, a better electric conductivity, a high machine-ability, a higher strength, a non-porous property and so on. By introducing the thinner metallic bipolar plate, for example a gold-plated bipolar Ni plate or an iron-based bipolar plate, the fuel cell can thus have a superior power/volume ratio.

Further, stainless steel such as SS316, SS310, or SS904L can be also introduced as a material of the metallic bipolar plate. The stainless-steel plate can have a surface oxide film which provides an extreme high resistance to, and thus protection against, surface oxidation. Yet, the oxide film of the stainless steel plate is a negative to contact resistance of the plate and generally leads to a substantial degradation of the cell performance.

At a bright side, a metallic bipolar plate of the stainless steel does extend the cell lifetime to, generally, a range between 1,000 and 3,000 service hours. Such a remarkable lifetime is extremely important to the fuel cells used in 3C (Computer, communication and consumer) products. However, as mentioned above, the existence of the oxide film has formed a problem to possible utilization of the bipolar plate of the stainless steel. Therefore, any effort in improving the surface quality of the metallic bipolar plate for fuel cells to provide enduring stability and corrosion-resistance is definitely welcome to the skilled person in the art.

### SUMMARY OF THE INVENTION

Accordingly, it is a primary object of the present invention to provide a surface film structure with improved chemical and electrochemical stability to the metallic bipolar plate of the fuel cell for enhancing surface corrosion resistance and reducing the contact resistance.

It is a further object of the present invention to provide a nano-structure to the surface of the metallic bipolar plate for obtaining hydrophobic and self-cleaning properties, by which any gas or fluid can flow freely over the bipolar plate without jamming the interior of the fuel cell.

It is one more object of the present invention to provide a finer surface for the metallic bipolar plate so as to reduce the contact resistance between the plate and the neighboring material.

In accordance with the present invention, a surface film structure of a metallic bipolar plate for fuel cells and a method for producing the same are provided. The method for producing the surface film structure is firstly to perform flow channel machining on a metallic bipolar plate by utilizing an electrical discharge machine (EDM), a computer numerical control (CNC) machine, an electrochemical mechanical polishing (ECM) machine, a laser machining machine, a press or an injection-molding machine. Then, surface grinding of the method is performed to remove any oxide film on the bipolar plate. Degreasing upon the bipolar plate is consequently done to remove possible oil on the bipolar plate. After the degreasing, the bipolar plate is dipped into an alkaline solution for ultrasonic cleaning. De-ionization by de-ion water upon the bipolar plate is then performed as the bipolar plate is removed off the alkaline solution. Thereafter, the bipolar plate is dipped into a nitric acid for a predetermined time and then is removed therefrom to be de-ionized by the de-ion water again. Then, the bipolar plate is dipped in pure water for further ultrasonic cleaning.

In the method of the present invention, the metallic bipolar plate undergone the aforesaid preparations is then arranged into an ECM tank for refining a surface roughness thereof to 0.02 μm. Upon previous ECM, an iron composition on the surface of the bipolar plate can be reduced while an Cr composition is increased. Thereby, a surface film structure with superior chemical and electrochemical stability can be provided to the metallic bipolar plate, in which the surface film can include a Cr composition of 40˜75%, an iron composition of 10˜30%, and an Ni composition of 15˜30%. By providing forgoing electrochemical technique to improve the surface structure of the metallic bipolar plate, a nano-scaled surface film with specific properties of the present invention can be achieved. The surface film is superior in corrosion-resistance, conductivity, and roughness (or say, smoothness). For a nano-structure has been applied to the surface film of the metallic bipolar plate, the plate is then hydrophobic and self-cleaning, and thus the surface stability and flowability can be substantially increased. Also, for the Cr composition in the surface film has been particularly increased, the corrosion resistance of the metallic bipolar plate is greatly enhanced.

By providing the nano-scaled and coherent structure to the surface film, both the chemical and physical properties of the metallic bipolar plate of the present invention can be improved.

In the present invention, the surface film of the metallic bipolar plate is formed as a protection coating with chemical and electrochemical stability that includes the Cr composition of 40˜75%, the iron composition of 10˜30%, and the Ni composition of 15˜30%.

### BRIEF DESCRIPTION OF THE DRAWINGS

The present invention will now be specified with reference to its preferred embodiment illustrated in the drawings, in which:

FIG. 1 shows a typical corrosion curve of linear polarization test;

FIG. 2 shows a typical I-V curve of the corrosion test;

FIG. 3 shows a depth profile from an AES analysis;

FIG. 4 shows contact resistances of the original and the processed specimens;

FIG. 5 shows I-V curves of fuel cells utilizing respectively the original and the processed specimens; and

FIG. 6 shows I-P curves of fuel cells utilizing respectively the original and the processed specimens.

### DESCRIPTION OF THE PREFERRED EMBODIMENT

The invention disclosed herein is directed to a surface film structure of a metallic bipolar plates for fuel cells and a method for producing the surface film. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the following embodiments of the present invention, materials for the bipolar plates of the stainless steel plates can be selected from SS304, SS307, SS316, SS316L, SS310, SS420, SS904, titanium alloys, or aluminum alloys. These materials for the metallic bipolar plates are all made of rolled products. Preparations of a metallic bipolar plate of the present invention from a rolled stainless steel plate are described as follows.

1. Performing flow channel machining on the stainless steel: The flow channel machining can be carried out by EDM or CNC machining. A typical dimension for the plate can be 90 mm×90 mm×3 mm or 90 mm×90 mm×1 mm. In the case that the CNC machining is applied, a typical flow channel can be a snake-shape channel with a width of 1.2 mm and a depth of 1 mm, and a typical plate can have four channels in total.

2. Grinding the plate: Anisotropic grinding by a No.600 SiC sandpaper can be applied to remove the coarse oxide film on the plate. Also, a further surface grinding can be applied to made the plate reach a predetermined surface finish.

3. Degreasing the plate: Three tanks can be used to degrease the plate. They are a first ultrasonic tank filled with an 60˜80° C. alkaline 136R solution, a second ultrasonic tank filled with 60˜70° C. diluted water, and a 3˜5% nitric acid tank. The alkaline 136R solution can be prepared by adding 30 g 136R powder to every liter of water. In the degreasing, the plate is firstly dipped into the first ultrasonic tank for a 5˜15-minute ultrasonic cleaning. Then, the plate is removed from the first ultrasonic tank and washed with de-ion water. Further, the plate is dipped into the nitric acid tank for 5˜10 minutes. Then, the plate is removed from the nitric acid tank and again washed with de-ion water. Finally, the plate is dipped into the second ultrasonic tank for a further ultrasonic cleaning. Upon such a degreasing treatment, the plate can be thoroughly cleaned.

4. Electrochemical machining the plate so as to form a surface film with acceptable chemical and electrochemical stability: The plate is arranged in an ECM tank filled with a predetermined electrolyte and having an auxiliary electrode. The electrolyte can include 50˜80% phosphoric acid, 25˜10% sulfuiric acid, 20˜5% lactic acid, 0.5˜1% wetting agent, 1˜2% metallic ion, and water. In the machining, the voltage of the ECM is about 2˜0 V, the operation time is 3˜25 minutes, and the spacing between the plate and the auxiliary (copper) electrode is about 3˜100 mm. After the ECM is complete, the surface of the plate can have a mirror-scale surface with a roughness less than 0.02 μm and a satisfied hydrophobic property against any adhering of particles. The reason for the plate able to obtain such properties is that, during the ECM, some metallic ions can be released to the plate surface so as to form a surface coating film structure with chemical and electrochemical stability. The surface film structure can include a Cr composition of 40˜75%, an iron composition of 10˜30%, and an Ni composition of 15˜30%. By providing forgoing electrochemical technique to the plate, superior properties in conductivity and chemical lo stability can be achieved.

In the present invention, the surface film of the metallic bipolar plate is formed as a protection coating with chemical and electrochemical stability that includes the Cr composition of 40˜75%, the iron composition of 10˜30%, and the Ni composition of 15˜30%.

Experiments and Results

Corrosion test:

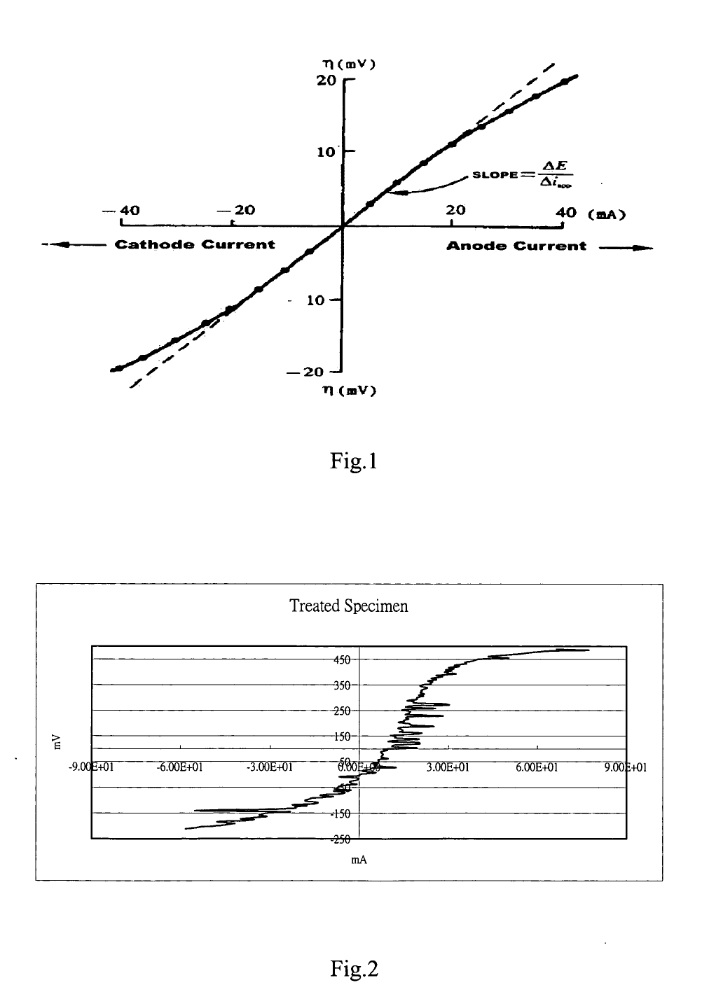

During the operation of a PEM fuel cell having the metallic bipolar plates as prepared above, the proton exchange membrane can dissolve acidic ions such as SO₄⁻, SO₃ ⁻ and HSO₄⁻. In the transfer between protons and electrons, a potential difference in the fuel cell can be induced to initiate possible electrochemical corrosion. The corrosion rate of the metallic bipolar plate can be estimated by the electrochemical corrosion measurement, particularly by the linear polarization method. From the Faraday's law, the corrosion rate R_{corr} can be calculated under a given surface area and a given process time.
R_{corr}=0.0032×(IA)/(nD) (1)
Rₚ=(βₐβ_{c})/(2.3I(βₐ+β_{c})) (2)

Where equation (1) is used to calculate the corrosion rate, I is the corrosion current, A/n is the gram-equivalent weight, and D is the weight density. The I can be derived from Equation (2) by firstly determining a slope Rₚ in a linear polarization test as shown in FIG. 1. The corrosion test is undergone in a room temperature. The solution for the test can be a 0.5M H₂SO₄. The pH value in the fuel cell environment is between 0 and 3.5, and the proton exchange is equivalent to 1M of H2SO4. In the test, a Solartron 1285 potentiostat which include a reference electrode (REF), a working electrode (WE) and an auxiliary electrode (AUX) can be used. The scanning range for the test can be between −0.5 V and −0.5 V (vs. OCP) and the scanning rate can be 10 mV/s.

Table 1 shows the results of the corrosion test. The electrochemical corrosion rate of an original bipolar plate specimen is 01 mmPy. From Table 1, it is noted that the average corrosion rate of the metallic bipolar plate specimens in accordance with the present invention is improved by about 66% over that of the original bipolar plate specimen. It means that the metallic bipolar plate of the present invention can run longer without significant electrochemical corrosion under a normal PEM fuel cell operation.

TABLE 1
Results of the corrosion tests

| | Corrosion | Result |
|---|---|---|
| Test no. | (mmPy) | (% improvement) |
| 1 | 3.54E−02 | 62.952% |
| 2 | 2.78E−02 | 70.881% |
| 3 | 3.21E−02 | 66.406% |
| 4 | 2.86E−02 | 70.018% |
| 5 | 3.03E−02 | 68.232% |
| 6 | 3.99E−02 | 58.200% |
| 7 | 3.82E−02 | 59.968% |
| 8 | 2.10E−02 | 78.027% |
| 9 | 3.57E−02 | 62.653% |
| Average | 3.21E−2 | 66.230% |

Metallurgical analysis of the surface film:

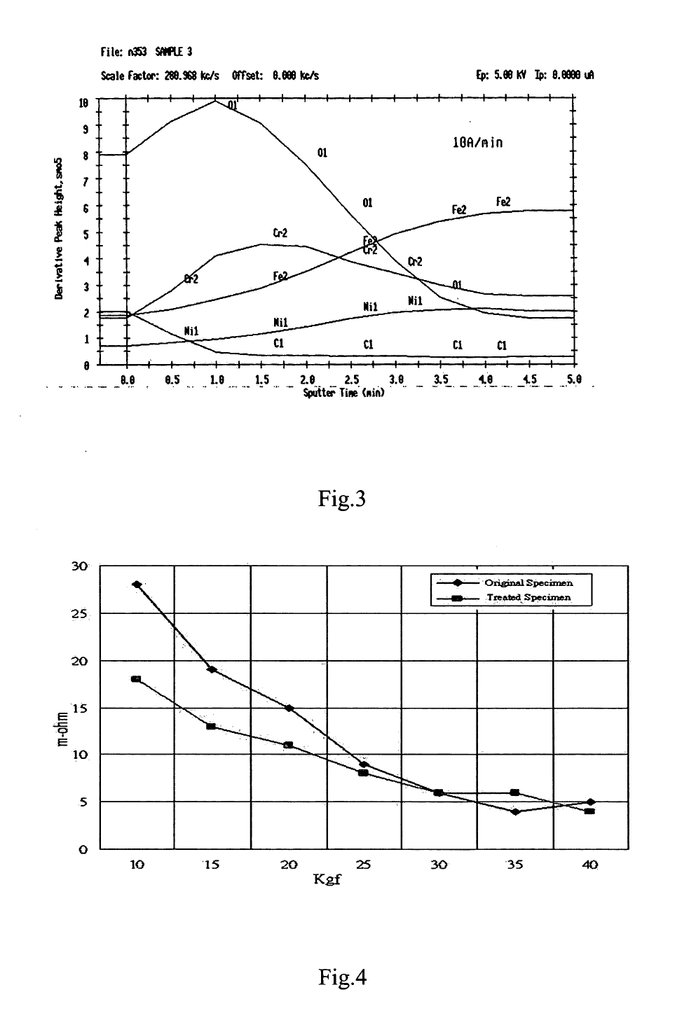

To understanding the metallurgy of the surface film of the metallic bipolar plate of the present invention after the aforesaid testing is completed, the metallic bipolar plate specimens are further analyzed by an electron spectroscopy for chemical analysis (ESCA) for major surface metallurgical compositions. The analysis results are listed in Table 2. Also, an Auger electron spectroscopy (AES) is introduced to investigate the depth profile of the surface film, and the results are shown in FIG. 3. From the results in Table 1, Table 2 and FIG. 3, it is noted that the compositional changes throughout the thickness of the surface film have made the metallic bipolar plate have superior chemical and physical properties. In the surface film, the Cr composition is increased while the iron composition is decreased. The surface film in each the metallic bipolar plate specimen is proved to have a Cr composition of 40˜75%, an iron composition of 10˜30%, and an Ni composition of 15˜30%. Therefore, the metallic bipolar plate of the invention can effectively extend the service lifetime of the bipolar plate and also can enhance the corrosion resistance.

TABLE 2
Results of ESCA analyses (wt. %)

| | Original | Processed |
|---|---|---|
| | specimen | specimen |
| Cr | 26.88% | 59.69% |
| Fe | 52.40% | 15.68% |
| Ni | 20.71% | 24.63% |
| Cr/Fe ratio | 0.51 | 3.81 |

Contact resistance test:

Referring now to FIG. 4, contact resistances of the original and the processed specimens of the present invention with respect to the pressure are shown. From FIG. 4, optimal parameters for a fuel cell assembly can be obtained. Also from FIG. 4, difference between the original specimen and the processed specimen (i.e. the metallic bipolar plate of the present invention) can be adopted to estimate the performance changes of the fuel cell affected by introducing the surface film of the present invention. Refer to FIG. 5 for such a test result.

Single cell test:

The fuel cell for testing mainly utilizes H₂ and O₂ and has a reaction area of 50 cm². The control interface is organized by Labview and Matlab. From a test station, the cell current vs. potential could be plotted.

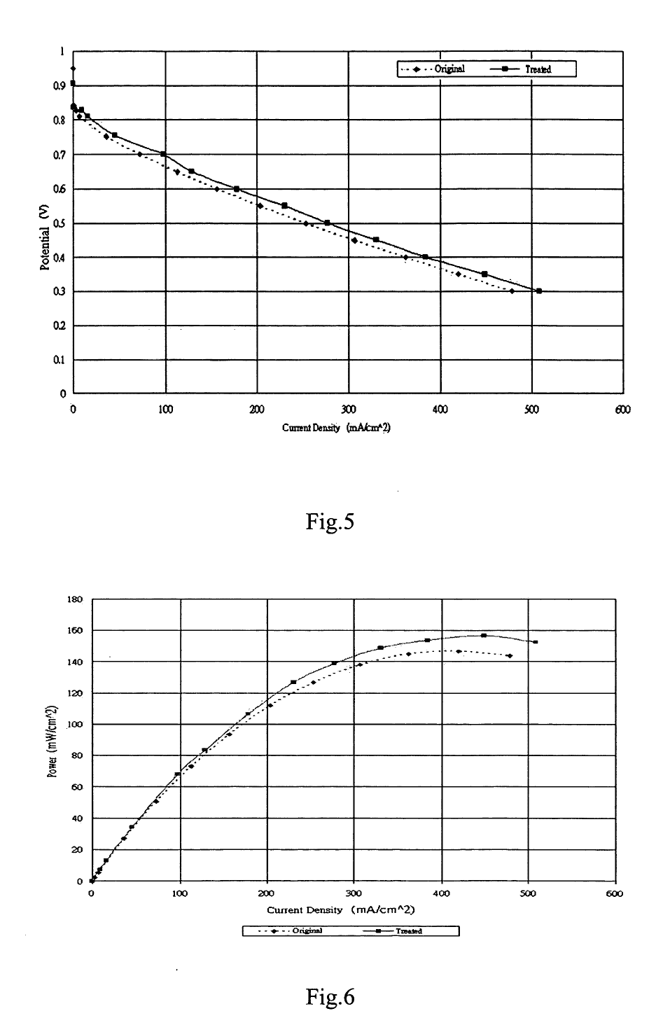

A typical single cell performance curve is basically composed of three regions: activity polarization, ohmic polarization and concentration polarization. The ohmic polarization is caused by electric conductivity of the ions in the electrolyte and the electrons in the electrodes. From the ohm's law, the over potential is
η=IR (3)

where I is the cell current and R is the cell resistances including includes electronic, ionic and contact resistances. The ohmic polarization is equivalent to the total internal resistance of the cell. Ideally, the cell should have a slow decline in I-V curve to avoid cell performance drop due to internal resistances. FIG. 5 and FIG. 6 shows the respective I-V and I-P curves of both the original and processed specimens.

In summary, the surface film of the metallic bipolar plate in accordance with the present invention specimen has a Cr composition of 40˜75%, an Fe composition of 10˜30%, and an Ni composition of 15˜30%. The higher the composition of the Ni or Cr is, the thinner the surface film is. Also, by providing the surface film structure of the present invention, the properties of the metallic bipolar plate in contact resistance, corrosion resistance, conductivity, roughness and hydrophobic performance can be improved. Thereby, the surface stability of the stainless steel bipolar plate in accordance with the present invention is greatly enhanced.

While the present invention has been particularly shown and described with reference to a preferred embodiment, it will be understood by those skilled in the art that various changes in form and detail may be without departing from the spirit and scope of the present invention.

1. A method for producing a surface film structure of a metallic bipolar plate for fuel cells, comprising:
a. performing flow channel machining on the metallic bipolar plate;
b. grinding the plate to remove a surface coating of the metallic bipolar plate;
c. degreasing the metallic bipolar plate; and
d. electrochemical machining the metallic bipolar plate so as to form a surface film thereon, wherein the surface film includes a Cr composition of 40˜75%, an iron composition of 10˜30%, and an Ni composition of 15˜30%.

2. The method for producing a surface film structure of a metallic bipolar plate for fuel cells according to claim 1, wherein said “flow channel machining” is performed by a machine selected from a group of an electrical discharge machine (EDM), a computer numerical control (CNC) machine, an electrochemical mechanical polishing (ECM) machine, a laser machining machine, a press and an injection-molding machine.

3. The method for producing a surface film structure of a metallic bipolar plate for fuel cells according to claim 1, wherein said metallic bipolar plate is made of a stainless steel.

4. The method for producing a surface film structure of a metallic bipolar plate for fuel cells according to claim 1, wherein said “grinding” is an anisotropic grinding.

5. The method for producing a surface film structure of a metallic bipolar plate for fuel cells according to claim 1, wherein said “degreasing” is performed by two ultrasonic tanks and a 3˜5% nitric acid tank.

6. The method for producing a surface film structure of a metallic bipolar plate for fuel cells according to claim 5, wherein one of said ultrasonic tanks is filled with an alkaline solution and another thereof is filled with diluted water.

7. The method for producing a surface film structure of a metallic bipolar plate for fuel cells according to claim 6, wherein said alkaline solution is prepared by adding 30 g 136R powder to every liter of water and is heated to a temperature of 60˜80° C.

8. The method for producing a surface film structure of a metallic bipolar plate for fuel cells according to claim 1, wherein said “electrochemical machining (ECM)” is performed in an ECM tank filled with a predetermined electrolyte and having an auxiliary electrode; wherein the electrolyte includes 50˜80% phosphoric acid, 25˜10% sulfuric acid, 20˜5% lactic acid, 0.5˜1% wetting agent, 1˜2% metallic ion, and water; wherein a voltage for said ECM is 2˜10V and an operation time thereof is 3˜25 minutes.

9. The method for producing a surface film structure of a metallic bipolar plate for fuel cells according to claim 8, wherein a spacing between said metallic bipolar plate and said auxiliary electrode is 3˜100 mm.

10. The method for producing a surface film structure of a metallic bipolar plate for fuel cells according to claim 1, wherein a surface roughness of said metallic bipolar plate after completing said step d is less than 0.02 μm.

11. A surface film structure of a metallic bipolar plate for fuel cells comprising a Cr composition of 40˜75%, an iron composition of 10˜30%, and an Ni composition of 15˜30%.
